(19) United States
(12) Patent Application Publication
(10) Pub. No.: US 2010/0141660 A1
(43) Pub. Date: Jun. 10, 2010

(54) IMAGE RENDERING PROCESSING DEVICE AND METHOD

(75) Inventor: Yoshiki Kobayashi, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/626,977

(22) Filed: Nov. 30, 2009

(30) Foreign Application Priority Data
Dec. 5, 2008 (JP) 2008-311354

(51) Int. Cl. G09G 5/26

(52) U.S. Cl. 345/472.2

(57) ABSTRACT

An image rendering processing device includes an expanding section, a signal output section, and a writing section. The expanding section reads out font data corresponding to the character code indicated in image rendering data and expands the font data into a size corresponding to horizontal and vertical pixel numbers of the image rendering data. The signal output section (a) reads out a valid range corresponding to the character code, (b) adjusts the valid range based on the pixels of the expanded font data, and counts the pixels in the expanded font data along the specific direction, and (c) outputs a valid signal indicating that a given pixel corresponds to the valid range when a counted pixel number matches the pixel number of a pixel corresponding to the valid range. The writing section writes the pixel that corresponds to the pixel number which is counted when the valid signal is output.

### CROSS-REFERENCE TO RELATED APPLICATION

This application claims priority under 35 USC 119 from Japanese Patent Application No. 2008-311354 filed on Dec. 5, 2008, the disclosure of which is incorporated by reference herein.

### BACKGROUND OF THE INVENTION

1. Field of the Invention

The present invention relates to an image rendering processing device and method that performs image rendering to displaying characters on a display or the like, and in particular relates to an image rendering processing device and method performing image rendering processing that includes kerning of a character string.

2. Description of the Related Art

A kerning method is proposed that, based on a character frame in which a character pattern is placed, moves the character spacing closer together and adjusts the placement of the characters when arraying two or more characters in sequence in a specific array direction. In such a kerning method, first a desired character spacing is specified between the respective character faces of a reference character that acts as a reference and an object character that has been placed following the reference character. Then, a supplementary line, orthogonal to the array direction of the characters, is drawn to the frame of the standard character and the object character as a portion of the character faces, the minimum spacing between the respective character faces of the standard character and the object character is calculated, and the minimum spacing as a specified character spacing, an amount by which the characters should be closed up (moved) is computed (see, for example, Japanese Patent Application Laid-Open (JP-A) No. 9-156066).

However, in the kerning method described in JP-A No. 9-156066, the character spacing must be specified for each of the characters. Further, the above kerning method is executed by software. In order to achieve similar processing using a hardware configuration, it is necessary to first generate a start address of a font memory in which the font data is stored and horizontal size of the font data according to the character spacing specified for each of the characters, and then read out the corresponding font from the font memory. This leads to complicated processing and configuration.

### SUMMARY OF THE INVENTION

The present invention is made in view of the above circumstances and provides an image rendering processing device and method that can eliminate process of specifying character spacing, and can perform kerning processing with a simple hardware configuration.

A first aspect of the present invention is an image rendering processing device including: an expanding section that, based on image rendering data including, for each of a plurality of characters, a number of horizontal pixels, a number of vertical pixels, and a character code, reads out font data corresponding to the character code indicated in the image rendering data, from a set of font data for character codes, each font data representing a character as a character pattern in a rectangular frame having a predetermined size, and that expands the read-out font data into a size corresponding to the horizontal pixel number and the vertical pixel number; a signal output section that (a) reads out a valid range corresponding to the character code indicated in the image rendering data from a set of valid range data used when performing kerning processing to array a plurality of characters along a specific direction such that the rectangular frames of adjacent characters overlap with each other, each valid range data indicating, for each character code, a valid range along the specific direction in which a character pattern is present but at which the adjacent characters do not overlap, (b) adjusts the read-out valid range based on the pixels of the expanded font data, and counts the pixels in the expanded font data along the specific direction, and (c) outputs a valid signal indicating that a given pixel corresponds to the valid range when a counted pixel number matches the pixel number of a pixel corresponding to the valid range; a writing section that, when writing the expanded font data one pixel at a time along the specific direction to an image rendering memory, writes the pixel that corresponds to the pixel number which is counted when the valid signal is output.

In the above aspect, font data representing the character as a character pattern in a predetermined size of rectangular frame is stored in advance for each character code, and also stored in advance for each character code is data used when performing kerning processing to array plural characters along a specific direction such that the rectangular frames of adjacent characters overlap with each, and data indicating a valid (effective) range along the specific direction in which a character pattern is included and the adjacent characters do not overlap each other.

When image rendering data including a number of horizontal pixels, a number of vertical pixels, and a character code for each character is input, based on this image rendering data the expanding section reads out font data corresponding to the character code included in the image rendering data, and expands the font data that has been read out into a size corresponding to the horizontal pixel number and the vertical pixel number. The signal output section adjusts the valid range corresponding to the character code included in the image rendering data to the pixels of the expanded font data, counts the pixels in the expanded font data along the specific direction, and outputs a valid signal indicating that a given pixel corresponds to the valid range when the given pixel number counted is the pixel number of a pixel corresponding to the valid range. The writing section writes the expanded font data one pixel at a time along the specific direction to an image rendering memory, such that the pixels that correspond to pixel numbers counted when the valid signal was output by the signal output section is written.

In this manner, process of specifying the character spacing for each character is eliminated, and kerning can be performed with a simple hardware configuration, since corresponding pixels of the font data are written to the image rendering memory when the valid signal based on the valid range that has been stored in advance was output.

The above aspect may further include a font storage section that stores the set of font data and a valid range storage section that stores the set of valid range data.

In addition, the font storage section and/or the valid range storage section may be storage means such a hard disk of an external device, or a portable storage media. The image rendering processing device may also be configured to include the font storage section and/or the valid range storage section.

In the above aspect, the set of valid range data may include, for each of the character codes, data indicating the position from the left edge and the position from the right edge of the rectangular frame of the font data corresponding to the character code.

In the above aspect, the set of valid range data may include, for each of the character codes, data corresponding to one line's worth of the font data, and comprises indications of a start position of the valid range and an end position of the valid range.

Another aspect of the present invention is a method of operating the image rendering processing device of the first aspect.

### BRIEF DESCRIPTION OF THE DRAWINGS

Exemplary embodiments of the present invention will be described in detail based on the following figures, wherein:

FIG. 1 is a schematic diagram showing a configuration of an image rendering processing device of a first exemplary embodiment;

FIG. 2 is a diagram showing an outline font based on font data;

FIG. 3 is a diagram of font data expanded into a bit map font;

FIG. 4 is a diagram explaining a left spacing, a right spacing, and a valid range of font data;

FIG. 5 is a schematic diagram showing a configuration of a valid signal output circuit of the image rendering processing device of the first exemplary embodiment;

FIG. 6 is a schematic configuration showing a configuration of a valid signal generation circuit;

FIG. 7 is a diagram explaining a relationship between font data, a font data enable signal, and a count value;

FIG. 8 is a diagram explaining writing to an image rendering memory;

FIG. 9 is a time chart showing operation of the image rendering processing device of the first exemplary embodiment;

FIG. 10 is a schematic diagram showing a configuration of an image rendering processing device according to a modified example of the first exemplary embodiment;

FIG. 11 is a schematic diagram showing a configuration of a valid signal output circuit, a table selection circuit and a valid range table of the image rendering processing device according to the modified example of the first exemplary embodiment;

FIG. 12A is a diagram showing an example of a character string that has not been subjected to kerning processing, FIG. 12B is a diagram showing an example of a character string that has been subjected to kerning processing with a wide spacing, and FIG. 12C is a diagram showing an example of a character string that has be subjected to kerning processing with a narrow spacing;

FIG. 13 is a schematic diagram showing a configuration of an image rendering processing device of a second exemplary embodiment;

FIG. 14 is a diagram for explaining a dummy line in the second exemplary embodiment;

FIG. 15 is a diagram of a dummy line and font data expanded into a bit map;

FIG. 16 is a schematic diagram showing a configuration of a valid signal output circuit of the image rendering processing device of the second exemplary embodiment; and

FIG. 17 is a time chart showing operation in the image rendering processing device of the second exemplary embodiment, up till refreshing the pixel number indicating the valid range.

### DETAILED DESCRIPTION OF THE INVENTION

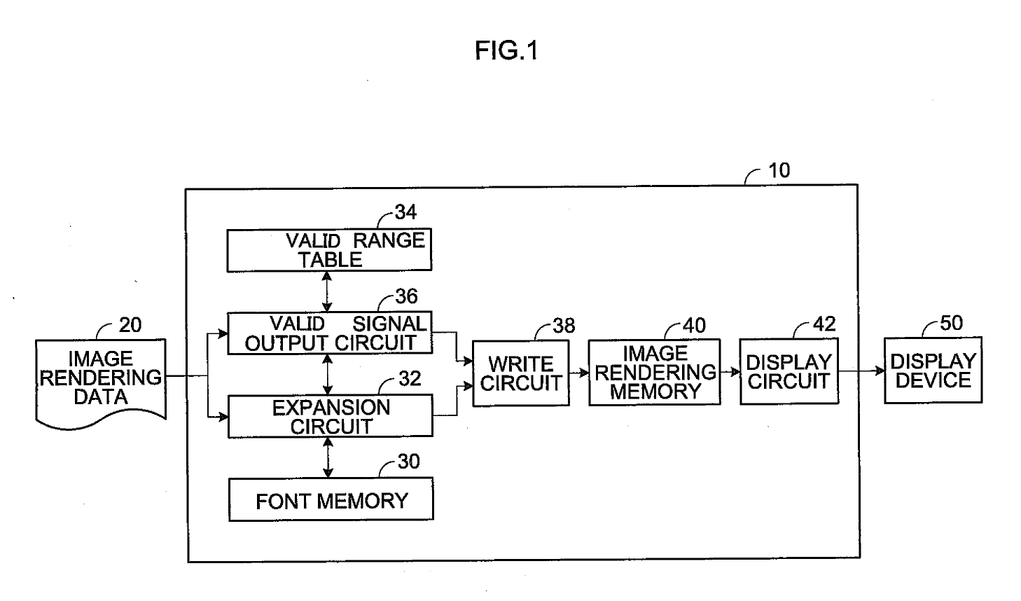

Explanation will now be given in detail of an exemplary embodiment of the present invention, with reference to the drawings. FIG. 1 is a schematic diagram showing a configuration of an image rendering processing device 10 of a first exemplary embodiment. The image rendering processing device 10 performs kerning processing on image rendering data 20 that has been input, and performs image rendering processing for display on a display device 50, such as a CRT, an LCD, or the like.

The image rendering data 20 is one character's worth of data for display on the display device 50. The image rendering data 20 includes image rendering start coordinates (x, y) indicating the position on the display device 50 for displaying the character, a character horizontal size CH and a character vertical size CV that indicate the character size corresponding to the pixel number of the display device 50, and a character code n of the character. A character string formed from plural characters is displayed on the display device 50 by inputting the image rendering data 20 sequentially.

The image rendering processing device 10 includes: a font memory 30 in which font data corresponding to characters is stored for each character code; an expansion circuit 32 that expands font data, corresponding to the character code n included in the inputted image rendering data 20, into a bit map font; a valid range table 34 storing valid ranges of the characters indicated by the font data for each character code; a valid signal output circuit 36 that generates and outputs a valid signal FDV based on a valid range corresponding to the character code n included in the input image rendering data 20 and based on the bit map font expanded by the expansion circuit 32; an image rendering memory 40 to which bit map fonts are written; a write circuit 38 that writes the bit map font to the image rendering memory 40 based on the bit map font expanded by the expansion circuit 32 and on the valid signal FDV output from the valid signal output circuit 36; and a display circuit 42 that reads out the bit map font that has been written to the image rendering memory 40 and outputs the bit map font to the display device 50.

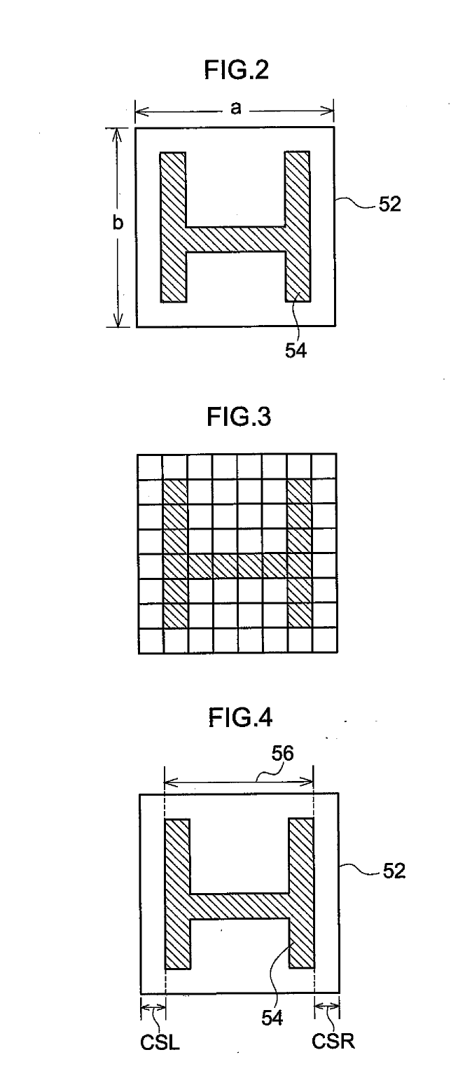

The font data stored in the font memory 30 is data indicating an outline font that is a character pattern 54 representing the shape of a character corresponding to the character code n, which is placed within a rectangular frame 52 of predetermined size (in this case horizontal a×vertical b), as shown in FIG. 2. Namely, the font data is data that expresses the character pattern 54 as coordinates of points of reference in the rectangular frame 52, and a collection of outline contours. The size of the rectangular frame 52 is common to all of the character codes.

The expansion circuit 32 reads out from the font memory 30 the font data corresponding to the character code n included in the image rendering data 20, and expands the font data to a bit map font of a size corresponding to the character horizontal size CH and the character vertical size CV which are included in the image rendering data 20. For example, if the character horizontal size CH and the character vertical size CV are both 8 pixels, when the font data of the outline font of FIG. 2 is expanded, the rectangular frame 52 of the font data is divided into an 8×8 vertical and horizontal lattice shape, and the outline font is expanded into a bit map font in which pixels at the positions where the character pattern 54 is placed are filled-in, as shown in FIG. 3.

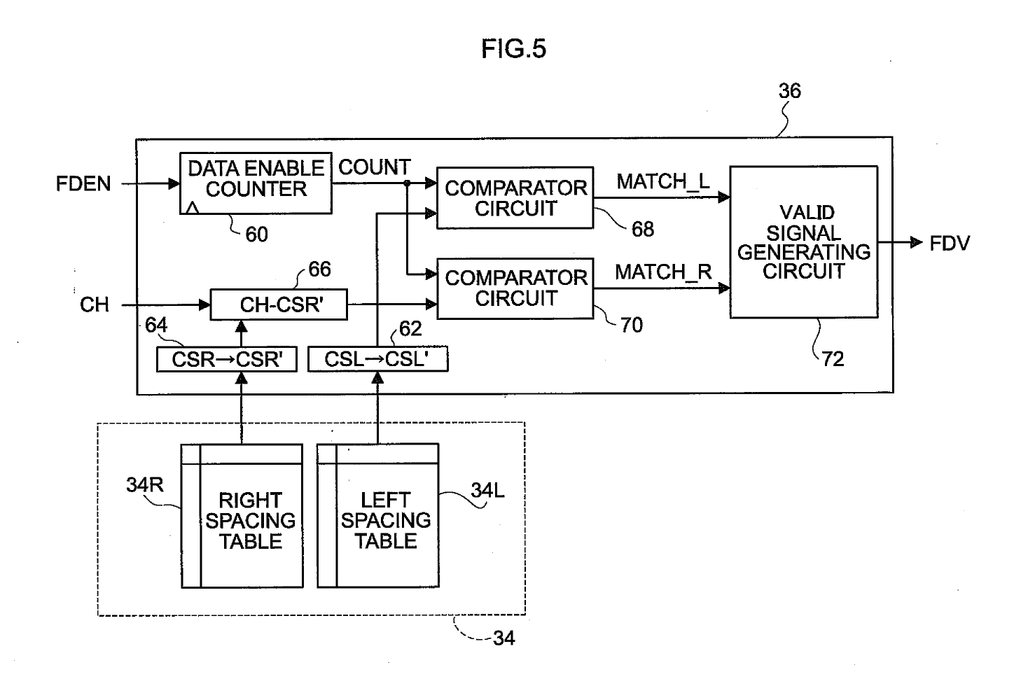

In the valid range table 34, a valid range that is the range of image rendering after kerning processing is performed on the characters represented by the font data is specified for each of the character codes. Specifically, as shown in FIG. 4, when the character string is aligned in a horizontal direction, a left spacing CSL indicating the distance from the left edge of the rectangular frame 52 and a right spacing CSR indicating the distance from the right edge of the rectangular frame 52 are respectively defined in a left spacing table 34L and a right spacing table 34R (see FIG. 5), in association with each of the character codes. By storing the left spacing CSL and the right spacing CSR for each of the character codes as the valid range table 34, a valid range 56 is indirectly stored as a region in the rectangular frame 52 excluding a left edge region of the width of the left spacing CSL and excluding a right edge region of the width of the right spacing CSR.

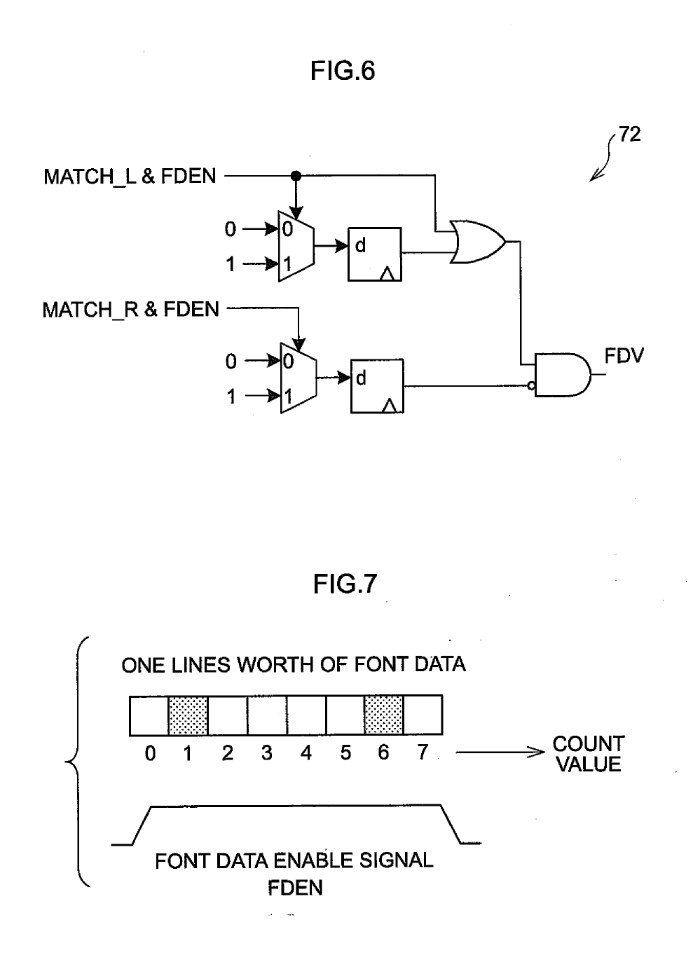

As shown in FIG. 5, the valid signal output circuit 36 includes: a data enable counter 60 that counts a font data enable signal FDEN, which is described later, and outputs the count value; a conversion circuit 62 that converts the left spacing CSL that has been read out from the left spacing table 34L into the pixel number corresponding to one line's worth of bit map font, namely, into a left spacing pixel number CSL′ that is the value corresponding to the character horizontal size CH; a conversion circuit 64 that converts, in a similar manner, the right spacing CSR into a right spacing pixel number CSR′; a subtraction circuit 66 that outputs a value obtained by subtracting the right spacing pixel number CSR′ input by the conversion circuit 64 from the input character horizontal size CH; a comparator circuit 68 that compares the count value input from the data enable counter 60 with the left spacing pixel number CSL′ input from the conversion circuit 62, and outputs a left match signal MATCH_L when these match; a comparator circuit 70 that compares the count value input from the data enable counter 60 with the value (CH-CSR′) input from the subtraction circuit 66, and outputs a right match signal MATCH_R when these match; and a valid signal generating circuit 72 that generates and outputs the valid signal FDV, based on the outputs of the comparator circuit 68 and the comparator circuit 70. Details of the valid signal generating circuit 72 are as shown in FIG. 6.

The font data enable signal FDEN input to the data enable counter 60 is a signal indicating that font data exists (has been read out) when performing write processing, one line at a time, for the font data read from the font memory 30 and expanded by the expansion circuit 32. The font data enable signal FDEN is asserted to value 1 when the font data exists. The data enable counter 60 counts this font data enable signal FDEN for every pixel, and outputs the count value. In a case of a bit map font of FIG. 3, for example, the font data enable signal FDEN is asserted to value 1 when the font data is present and count values of 0 to 7 are output for the 8 pixels which are present, as shown in FIG. 7.

The conversion circuits 62 and 64 convert the left spacing CSL and the right spacing CSR, which are read respectively from the left spacing table 34L and the right spacing table 34R, into the left spacing pixel number CSL′ and the right spacing pixel number CSR′, which are corresponding to the character horizontal size CH, and output these values. For example, when the outline font of FIG. 2 and FIG. 4 is expanded to the bit map font of FIG. 3, when the horizontal size a of the rectangular frame 52 is made to correspond to the character horizontal size CH, if the left spacing CSL corresponds to a width of one pixel, then the left spacing pixel number CSL′ is “1”. The right spacing CSR is also converted into the right spacing pixel number CSR′ in a similar manner.

The comparator circuit 68 outputs the left match signal MATCH_L all the time from when the count value matches the left spacing pixel number CSL′ until the end of a line. Since the count values here are 0 to 7, the left match signal MATCH_L is output from the time when the first pixel corresponding to the valid range 56 is read. Namely, the left match signal MATCH_L is a signal indicating the start position of the valid range 56. The comparator circuit 70 outputs the right match signal MATCH_R all the time from when the count value matches (CH-CSR′) until the end of a line. (CH-CSR′) is the pixel number indicating the end of the valid range 56, and since the count values here are 0 to 7, the right match signal MATCH_R is output from the time when the first pixel corresponding to the right spacing region is read. Namely, the right match signal MATCH_R is a signal indicating the end position of the valid range 56.

The valid signal generating circuit 72 generates the valid signal FDV from the left match signal MATCH_L and the right match signal MATCH_R. The left match signal MATCH_L is a signal indicating the start position of the valid range and the right match signal MATCH_R is a signal indicating the end position of the valid range. Therefore, the valid signal FDV is generated and output when the left match signal MATCH_L is being output and the right match signal MATCH_R is not being output.

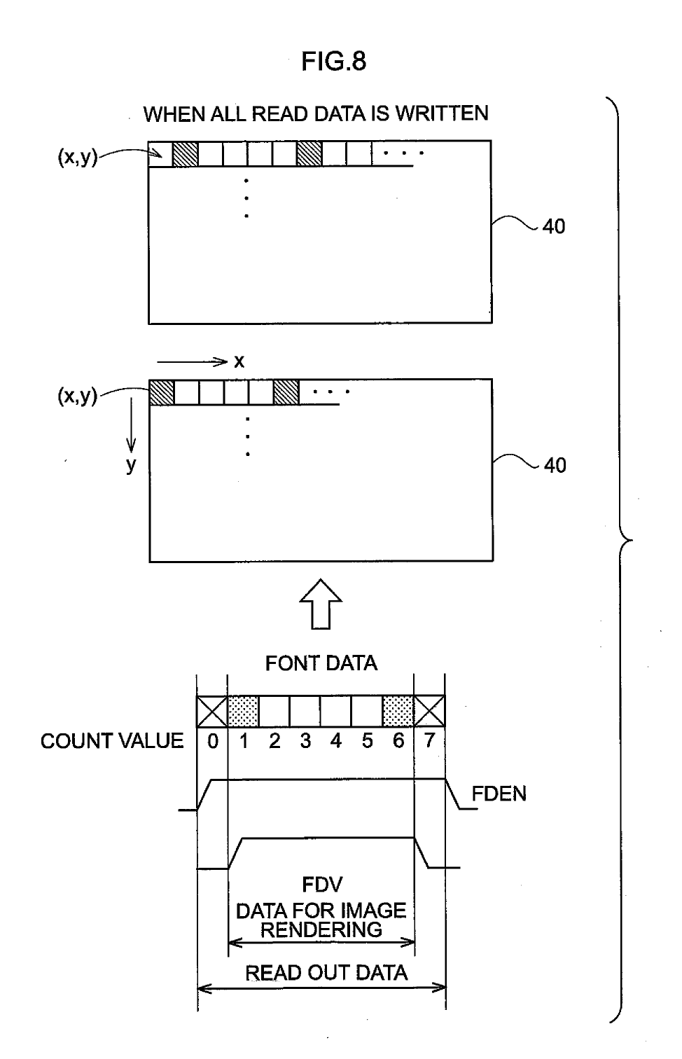

The write circuit 38 writes to the image rendering memory 40 only the pixels corresponding to the count value when the valid signal FDV is being output, from a write start position determined based on the image rendering start coordinates (x, y) included in the image rendering data 20. Thus, as shown in FIG. 8, since only the pixels from the read data corresponding to the count values when the valid signal FDV is being output (the pixels corresponding to count values 1 to 6) are written to the image rendering memory 40, a character image is rendered such that the character spacing is closed up at the front and rear by the pixels corresponding to the count values 0 and 7.

Explanation will now be given of operation of the image rendering processing device 10 of the first exemplary embodiment. In this example the image rendering data 20 that is input includes an image rendering start coordinate of (1, 1) (corresponding to the region at the left top corner of the image rendering memory 40), a character horizontal size CH=8 pixels, a character vertical size CV=8 pixels and a character code n=08 (character code corresponding to the character “H”). The left spacing CSL and the right spacing CSR corresponding to the character code 08 are specified in the left spacing table 34L and the right spacing table 34R, and are both “1” when converted into the left spacing pixel number CSL′ and the right spacing pixel number CSR′.

The image rendering data 20 is first input to the expansion circuit 32, the font data corresponding to the character code 08 is read from the font memory 30 and expanded into a bit map font of 8 pixels horizontally×8 pixels vertically. When the image rendering data 20 is input to the valid signal output circuit 36, the left spacing CSL and the right spacing CSR that correspond to the character code 08 are read out from the left spacing table 34L and the right spacing table 34R, respectively, and converted into the left spacing pixel number CSL′ (“1”) and the right spacing pixel number CSR′ (“1”) that correspond to the character horizontal size of 8 pixels. With respect to the right spacing pixel number CSR′, a value is calculated that the right spacing pixel number CSR′ subtracted from the character horizontal size CH (CH-CSR′=“7”).

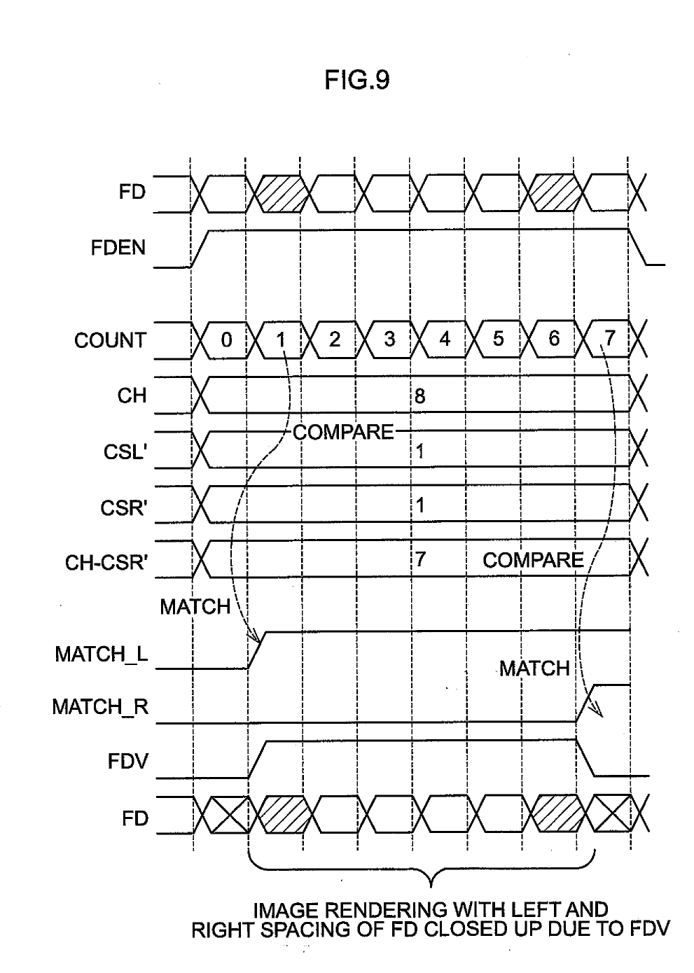

Next, the following processing is performed on the font data that has been expanded into a bit map font as shown in FIG. 3, one line at a time starting from the pixel at the left top corner. A time chart is shown in FIG. 9 of performing the processing of the second line.

When the processing of the second line is started, and the presence of the first pixel of the font data has been confirmed, the font data enable signal FDEN is asserted to value 1. The font data enable signal FDEN is counted for each pixel, and count value “0” is output first. By respective comparisons, determination is made for each comparisons of the count value and CSL′ as to whether or not the count value matches CSL′, and for each comparisons of the count value and (CH-CSR′) as to whether or not the count value matches (CH-CSR′). In this case, none of these match, since the count value=0, the CSL′=1, and (CH-CSR′)=7. Consequently, the valid signal FDV is not generated and not output, and the first pixel corresponding to the count value “0” is not written to the image rendering memory 40.

Next, count value “1” is output for the second pixel. The left match signal MATCH_L is output since the count value=1 matches the CSL′=1. The left match signal MATCH_L is output until the end of the line. The right match signal MATCH_R is not output since the count value=1 does not match the (CH-CSR′)=7. This state indicates that the valid range has started, and therefore, the valid signal FDV is output. The second pixel, corresponding to the count value=1 when the valid signal FDV is being output, is written to a region of the image rendering memory 40 corresponding to the coordinate (1, 2), with reference to the image rendering start coordinate (1, 1). The coordinate (1, 2) is determined since this is the second line of the font data, which is to be written at (x, y+1) with respect to the image rendering start coordinate (x, y). The font data for the second pixel is data of a filled-in pixel, and therefore “1” is written to the image rendering memory 40.

For the third to seventh pixels, the count values=2 to 6, respectively, and since the status of the signals does not change from that at the second pixel, the third to seventh pixels are sequentially written to the image rendering memory 40. Note that the font data of the third to pixels are data for non-filled-in pixels, and therefore “0” is written to the image rendering memory 40, and, the font data for the seventh pixel is data for a filled-in pixel, and therefore “1” is written to the image rendering memory 40.

The count value “7” is then output for the eighth pixel. The right match signal MATCH_R is output since the count value=7 matches the (CH-CSR′)=7. This state indicates that the valid range has ended, and therefore, the output of the valid signal FDV is terminated. Consequently, the valid signal FDV is not generated and not output thereafter, and the eighth pixel corresponding to the count value “7” is not written to the image rendering memory 40.

Since the eighth pixel is the final pixel of one line, the font data enable signal FDEN is negated after the processing of the eighth pixel, and processing moves to the next line. By repeatedly performing the above processing until the final line, 1 character's worth of font data is written to the image rendering memory 40 in a state such that the left and right spaces thereof are closed up respectively by the left spacing pixel number CSL′ and the right spacing pixel number CSR′.

When the image rendering processing for one character is completed, a signal generation circuit (not illustrated) generates a signal indicating the image rendering start coordinate (x, y) included in the next image rendering data 20 prior to input of the next image rendering data 20. This signal can be generated, for example, based on an address indicating the end position of font data writing based on the previous image rendering data 20. When the image rendering data 20 has the image rendering start coordinate (x, y) prior to the closing up of the character, the image rendering start coordinate (x, y) of the image rendering data 20 may be refreshed with the coordinates (x′, y) obtained by subtracting the amount of character close-up of the previous image rendering data 20 from the image rendering start coordinate (x, y), i.e., x′=x−(CSL′+CSR′).

As explained above, according to the image rendering processing device of the first exemplary embodiment, it is not necessary to specify the character spacing for each character, and kerning processing can be performed with a simple hardware configuration.

Explanation will now be given of a modified example of the first exemplary embodiment. In the modified example of the first exemplary embodiment, plural left spacing tables and right spacing tables are respectively held as the valid range table, and selection of kerning processing with wide character spacing and kerning processing with narrow character spacing can be can be accomplished by switching the table from which the left spacing and the right spacing are to be read-out. The same reference numerals are applied for parts of the configuration similar to that of the image rendering processing device 10 of the first exemplary embodiment, and explanation thereof is omitted.

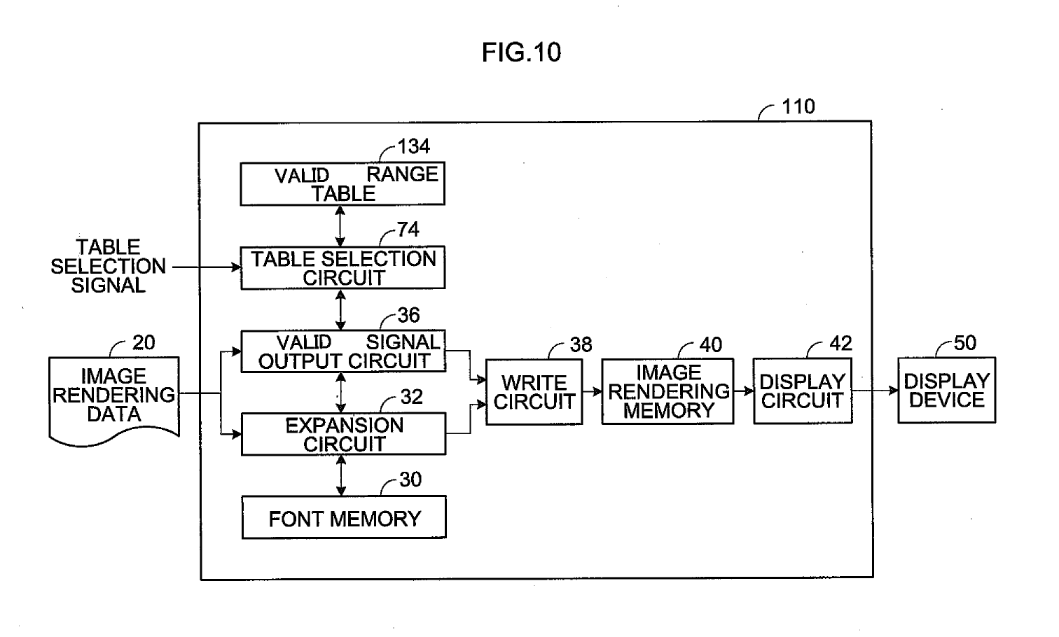

As shown in FIG. 10, an image rendering processing device 110 according to the modified example of the first exemplary embodiment includes a valid range table 134 including plural tables having different kerning spacing, and a table selection circuit 74 that selects a table from the valid range table 134 according to a table selection signal.

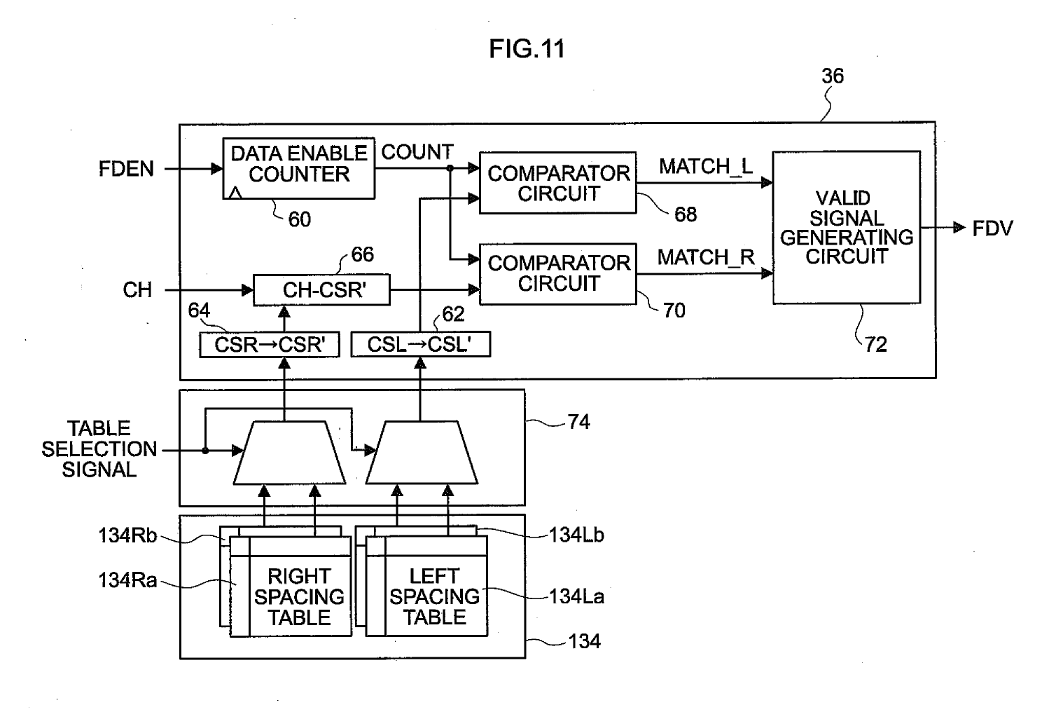

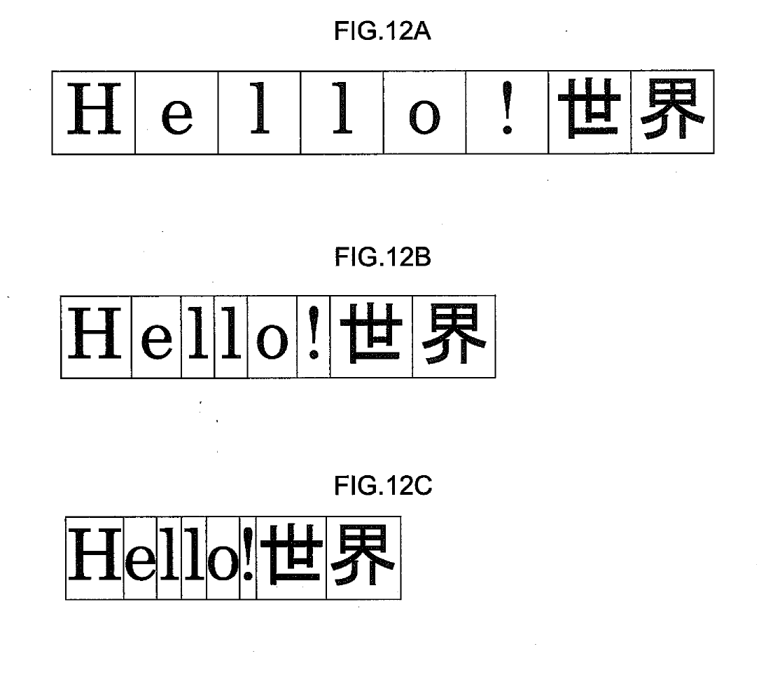

The valid range table 134 includes, as shown in FIG. 11, left spacing tables 134La and 134Lb in which the left spacing CSL is specified for each character code, and right spacing tables 134Ra and 134Rb in which the right spacing CSR is specified for each of the character codes. For the same character code, a left spacing CSLa specified in the left spacing table 134La has a smaller value than a left spacing CSLb specified in the left spacing table 134Lb. Similarly, the right spacing CSRa specified in the right spacing table 134Ra has a smaller value that a right spacing CSRb specified in the right spacing table 134Rb. The smaller the values of the left spacing CSL and the right spacing CSR, the wider the valid range 56. Consequently, when the character string that has not been kerning processed as shown in FIG. 12A is subjected to a kerning process using the left spacing table 134La and the right spacing table 134Ra, wide kerning is performed as the spacing shown in FIG. 12B. When the character string that has not been kerning processed as shown in FIG. 12A is subjected to a kerning process using the left spacing table 134Lb and the right spacing table 134Rb, narrow kerning is performed as the spacing shown in FIG. 12C.

When the left spacing CSL and the right spacing CSR corresponding to the character code n included in the image rendering data 20 are read out, if the input table selection signal indicates to perform the kerning processing with wide spacing, the table selection circuit 74 selects the left spacing table 134La and the right spacing table 134Ra. On the other hand, when the input table selection signal indicates to perform the kerning processing with narrow spacing, then the table selection circuit 74 selects the left spacing table 134Lb and the right spacing table 134Rb. The table selection signal may be included in and input with the image rendering data 20.

As explained above, the image rendering processing device according to the modified example of the first exemplary embodiment has two left spacing tables and two right spacing tables that specify different values respectively for the left spacing and the right spacing corresponding to each character code. Consequently, kerning processing with wide spacing and kerning processing with narrow spacing can be selectively performed by switching tables for reading out the respective left spacing and right spacing.

Note that although the modified example of the first exemplary embodiment includes two tables for each of the left spacing and the right spacing, there may be three or more tables provided. In such configuration, further gradation can be selected for the character close-up spacing in the kerning processing.

Explanation will now be given of a second exemplary embodiment. Parts of the configuration that are similar to those of the image rendering processing device 10 of the first exemplary embodiment are allocated the same reference numerals, and explanation thereof is omitted.

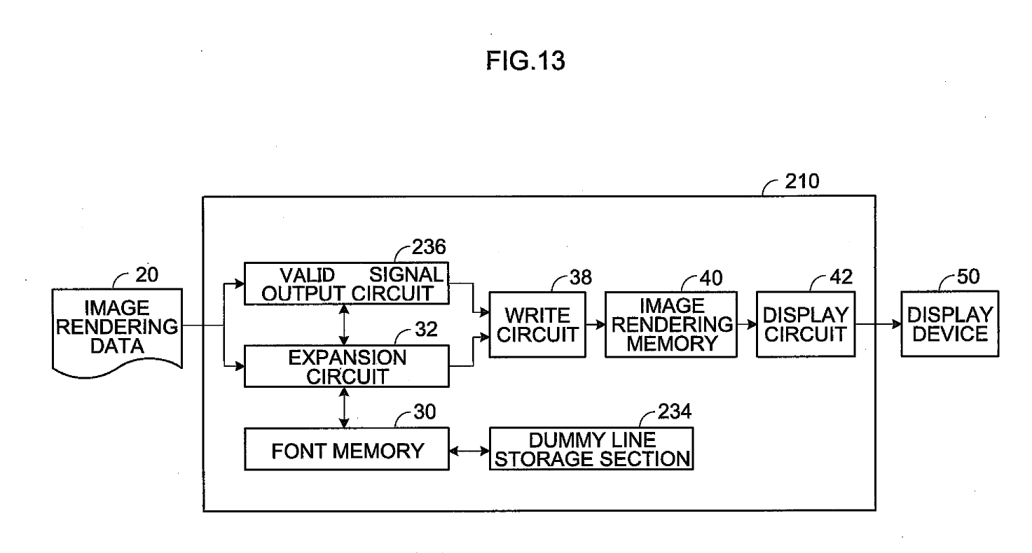

As shown in FIG. 13, an image rendering processing device 210 of the second exemplary embodiment includes a dummy line storage section 234 in which a dummy line, which is data corresponding to one line of font data and including markers for the left spacing CSL and the right spacing CSR, is stored for each of the character codes.

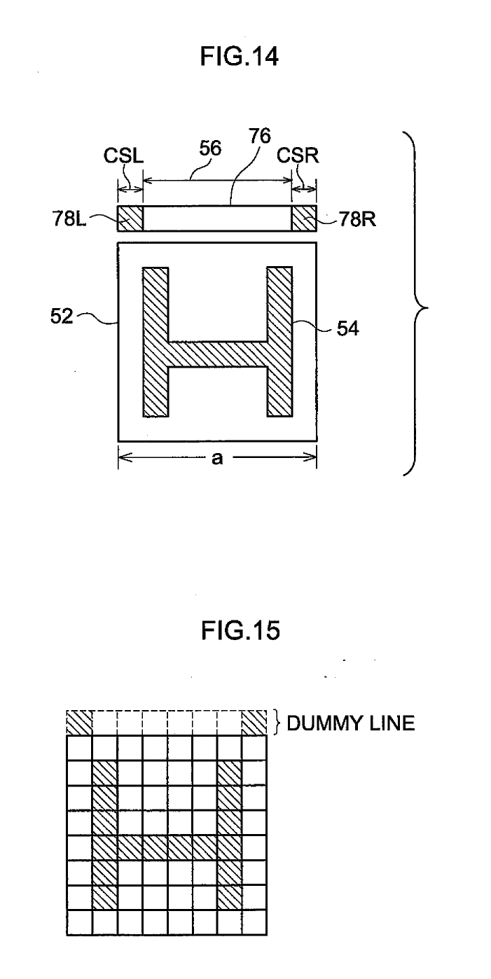

The dummy line, as shown in FIG. 14, is data expressing a pattern within a rectangular frame 76 of a horizontal size that is the same as the horizontal size a of the outline font rectangular frame 52 of the font data. A left spacing pattern 78L indicating the end position of the left spacing CSL and a right spacing pattern 78R indicating the start position of the right spacing CSR are disposed in the pattern. The dummy line is stored in association with the character codes, and when the expansion circuit 32 reads out, from the font memory 30, the font data corresponding to the character code n included in the image rendering data 20, the expansion circuit 32 also reads out the dummy line corresponding to the character code n at the same time.

In the expansion circuit 32, the dummy line that has been read out is expanded into bit map data corresponding to one line having a size of the character horizontal size CH included in the image rendering data 20×a vertical size of one pixel. For example, if the character horizontal size CH is 8 pixels, then the dummy line of FIG. 14 is expanded by dividing the rectangular frame 76 of the dummy line into a lattice shape of 1×8 boxes, and filling pixels corresponding to the positions at which the left spacing pattern 78L and the light spacing pattern 78R are disposed, as shown in FIG. 15. The read out font data is expanded into the bit map font in a similar manner to as in the first exemplary embodiment, and the bit map data of the expanded dummy line is combined with the font data such that the dummy line is appended above the first line of the bit map font.

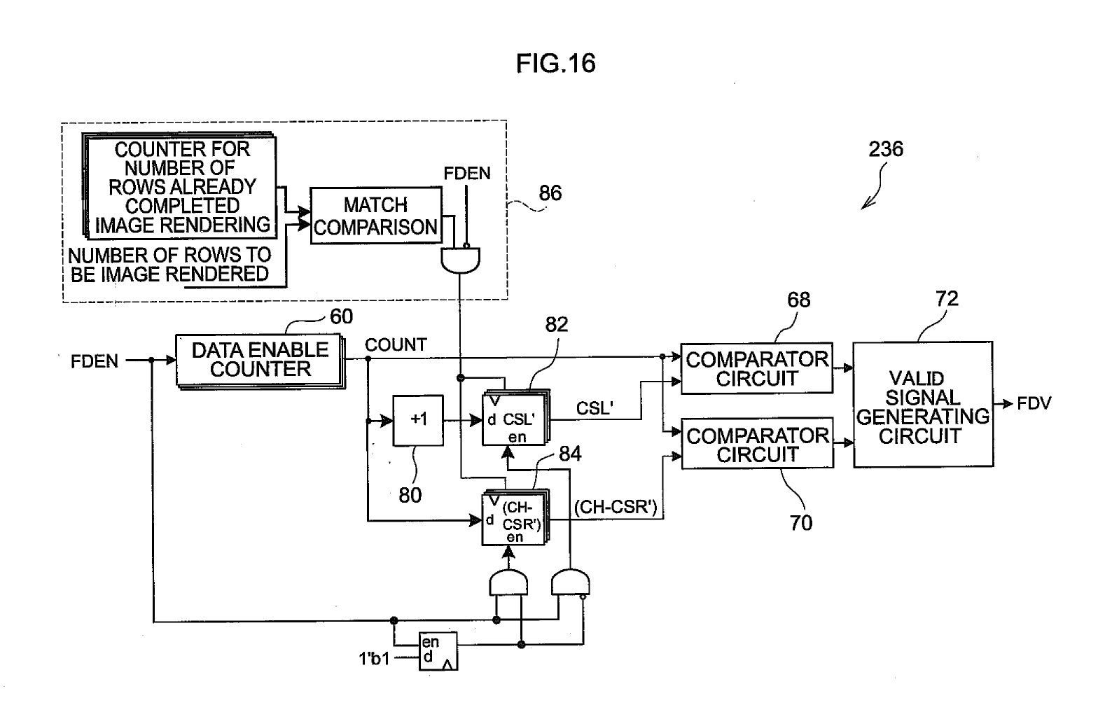

As shown in FIG. 16, a valid signal output circuit 236, includes: the data enable counter 60: an addition circuit 80 that adds one to the count value when the marker for the left spacing is detected in the dummy line; a CSL′ holding section 82 that holds the addition result of the addition circuit 80 as a value of the left spacing pixel number CSL′; a (CH-CSR′) holding section 84 that holds the count value when the marker for the right spacing is detected in the dummy line, as a value of the character horizontal size CH from which the right spacing pixel number CSR′ is subtracted; a reset circuit 86 that resets the values of the CSL′ holding section 82 and the (CH-CSR′) holding section 84 for each image rendering data 20; the comparator circuit 68 that compares the count value input from the data enable counter 60 with the left spacing pixel number CSL′ input from the CSL′ holding section 82 and outputs a left match signal MATCH_L when these match; the comparator circuit 70 that compares the count value input from the data enable counter 60 with the value (CH-CSR′) input from the (CH-CSR′) holding section 84 and outputs a right match signal MATCH_R when these match; and the valid signal generating circuit 72 that generates and outputs the valid signal FDV based on the outputs of the comparator circuit 68 and the comparator circuit 70.

Explanation will now be given regarding the portions that differ from the first exemplary embodiment with respect to the operation of the image rendering processing device 210 of the second exemplary embodiment. The image rendering data 20 input here includes an image rendering start coordinate (1, 1) (corresponding to the region of the left upper corner of the image rendering memory 40), a character horizontal size CH=8 pixels, a character vertical size CV=8 pixels, and a character code n=08 (the character code corresponding to the character “H”). Further, the dummy line corresponding to the character code 08 and expanded into bit map data includes markers corresponding to the left spacing CSL and the right spacing CSR at the first pixel and the eighth pixel.

When the image rendering data 20 is input to the expansion circuit 32, the font data corresponding to the character code 08 is read out from the font memory 30 and expanded into a bit map font of 8×8 pixels. The dummy line corresponding to the character code 08 is also read out from the dummy line storage section 234, expanded into bit map data of 8×1 pixels, and combined with the font data such that the dummy line is appended above the first line of the bit map font.

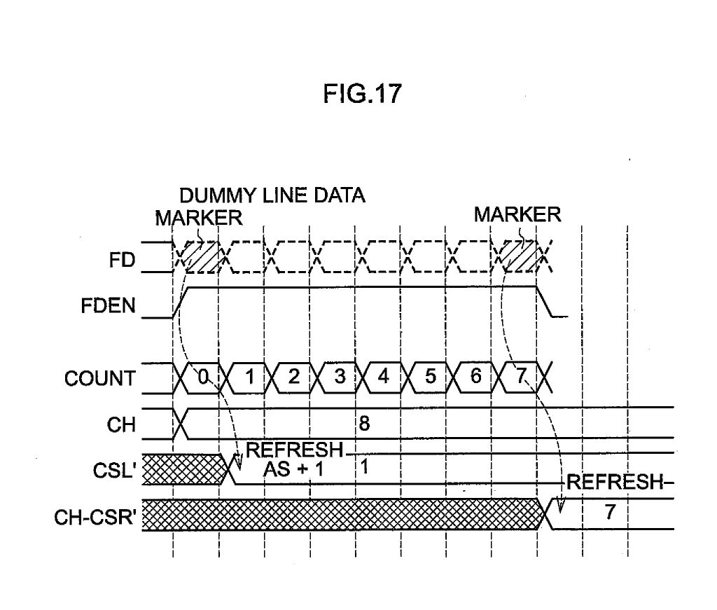

Next, processing is performed to the first line of the font data that have been expanded into bit map data as shown in FIG. 15, i.e., namely processing is performed on the line corresponding to the dummy line. A time chart for the processing performed on the dummy line is shown in FIG. 17.

Processing of the first line starts, and when the first pixel of the dummy line is detected, the font data enable signal FDEN is asserted to 1. The font data enable signal FDEN is counted for each pixel, and a count value of “0” is output first. A marker indicating the end position of the left spacing is placed at the first pixel which corresponds to the count value=0, and upon detection thereof, the value of the left spacing pixel number CSL′ held in the CSL′ holding section 82 is refreshed with a value of the count value=0+1. Since the marker indicates the end position of the left spacing, and the valid range starts from the next pixel of this marker, value 1 is added to the count value.

Regarding the second to the seventh pixels, count values=2 to 6 are output, and since no marker is detected, the continues until the eighth pixel, at which a count value of “7” is output. A marker indicating the start position of the right spacing is placed at the eighth pixel, corresponding to count value=7, and when this is detected, the (CH-CSR′) obtained by subtracting the right spacing pixel number CSR′ from the character horizontal size CH and held in the (CH-CSR′) holding section 84, is refreshed by the count value=7.

Thereafter, image rendering involving the kerning processing can be performed in a similar manner to that of the first exemplary embodiment by using the values of the CSL′ and the (CH-CSR′) held in the CSL′ holding section 82 and the (CH-CSR′) holding section 84, respectively.

Further, the reset circuit 86 counts the number of completed rows that have already been written to the image rendering memory 40, compares the row number with the character vertical size CV included in the input image rendering data 20, and outputs a reset signal to reset the values held in the CSL′ holding section 82 and the (CH-CSR′) holding section 84 when the comparison matches. The CSL′ and the (CH-CSR′) can thereby be specified for each of the image rendering data 20, namely for each character.

According to the image rendering processing device of the second exemplary embodiment as explained above, by storing a dummy line having markers for the right spacing and the left spacing, for each of the character codes, it is not necessary to specify the character spacing for each character, and kerning processing can be performed with a simple hardware configuration, as in the first exemplary embodiment.

The second exemplary embodiment may be configured to be capable of kerning processing with different spacing, as in the modified example of the first exemplary embodiment. For example, two types of markers may be provided in the dummy line, and the spacing of kerning can be set in different spacing by selecting the right spacing and left spacing to be read out by switching circuits for detecting the markers.

Explanation has been given for exemplary embodiments for cases in which character spacing is closed up in a horizontal direction for a character string arrayed in a horizontal direction. However, embodiments are not limited to this, and it can be also applied to cases of closing up the character spacing in a vertical direction for a character string arrayed in the vertical direction. In such cases, in place of the left spacing and the right spacing, the top spacing and the bottom spacing may be stored as the values indicating the valid range.

In addition, while explanation has been given for exemplary embodiments of image rendering processing devices having a configuration including a font memory, a valid range table, and a dummy line storage section, embodiments are not limited thereto. A configuration in which the font data, the valid range table, and/or the dummy line data are stored on and read out from a storage means such as a hard disk of an external device or the like, or stored on a portable storage medium such as a memory stick or the like.

As explained above, the image rendering processing device of the exemplary embodiments eliminate the process of specifying the character spacing, and the kerning processing can be performed with a simple hardware configuration.

What is claimed is:

1. An image rendering processing device comprising:
an expanding section that, based on image rendering data comprising, for each of a plurality of characters, a number of horizontal pixels, a number of vertical pixels, and a character code, reads out font data corresponding to the character code indicated in the image rendering data, from a set of font data for character codes, each font data representing a character as a character pattern in a rectangular frame having a predetermined size, and that expands the read-out font data into a size corresponding to the horizontal pixel number and the vertical pixel number;
a signal output section that (a) reads out a valid range corresponding to the character code indicated in the image rendering data from a set of valid range data used when performing kerning processing to array a plurality of characters along a specific direction such that the rectangular frames of adjacent characters overlap with each other, each valid range data indicating, for each character code, a valid range along the specific direction in which a character pattern is present but at which the adjacent characters do not overlap, (b) adjusts the read-out valid range based on the pixels of the expanded font data, and counts the pixels in the expanded font data along the specific direction, and (c) outputs a valid signal indicating that a given pixel corresponds to the valid range when a counted pixel number matches the pixel number of a pixel corresponding to the valid range;
a writing section that, when writing the expanded font data one pixel at a time along the specific direction to an image rendering memory, writes the pixel that corresponds to the pixel number which is counted when the valid signal is output.

2. The image rendering processing device of claim 1, further comprising:
a font storage section that stores the set of font data; and
a valid range storage section that stores the set of valid range data.

3. The image rendering processing device of claim 1, wherein the set of valid range data comprises, for each of the character codes, data indicating the position from the left edge and the position from the right edge of the rectangular frame of the font data corresponding to the character code.

4. The image rendering processing device of claim 1, wherein the set of valid range data comprises, for each of the character codes, data corresponding to one line's worth of the font data, and comprises indications of a start position of the valid range and an end position of the valid range.

5. An image rendering method comprising:
reading out, based on image rendering data comprising, for each of a plurality of characters, a number of horizontal pixels, a number of vertical pixels, and a character code, font data corresponding to the character code indicated in the image rendering data, from a set of font data for character codes, each font data representing a character as a character pattern in a rectangular frame having a predetermined size;
expanding the read-out font data into a size corresponding to the horizontal pixel number and the vertical pixel number;
reading out an valid range corresponding to the character code indicated in the image rendering data from a set of valid range data used when performing kerning processing to array a plurality of characters along a specific direction such that the rectangular frames of adjacent characters overlap with each other, each valid range data indicating, for each character code, an valid range along the specific direction in which a character pattern is present but at which the adjacent characters do not overlap;
adjusting the read-out valid range based on the pixels of the expanded font data;
counting the pixels in the expanded font data along the specific direction;
outputting a valid signal indicating that a given pixel corresponds to the valid range when a counted pixel number matches the pixel number of a pixel corresponding to the valid range; and
writing the expanded font data one pixel at a time along the specific direction, by writing the pixel that corresponds to the pixel number which is counted when the valid signal is output.
